(19) United States
(12) Patent Application Publication
(10) Pub. No.: US 2007/0251347 A1
(43) Pub. Date: Nov. 1, 2007

(54) Positioning device

(75) Inventors: Chien-Ta Lin, Taichung City (TW); Chia-Wei Chen, Taichung City (TW)

Correspondence Address: OSTROLENK FABER GERB & SOFFEN, 1180 AVENUE OF THE AMERICAS, NEW YORK, NY, 100368403, US

(73) Assignee: Universal Scientific Industrial Co., Ltd.

(21) Appl. No.: 11/391,772

(22) Filed: Mar. 28, 2006

(51) Int. Cl. G05G 5/06

(52) U.S. Cl. 74/527

(57) ABSTRACT

A positioning device with position-indicating capability includes: a slide-mounting part formed with a plurality of retaining holes and having a contacting wall that is formed with a plurality of recessed portions corresponding respectively to the retaining holes; a slider slidable on the slide-mounting part; an engaging member having an engaging protrusion capable of releasably engaging or disengaging a selected one of the retaining holes and co-slidable with the slider; and a position-indicating unit co-slidable with the slider and including a spring arm that has a free end in sliding contact with a corresponding one of the recessed portions of the contacting wall when the engaging protrusion is aligned with the selected retaining hole.

### BACKGROUND OF THE INVENTION

1. Field of the Invention

This invention relates to a positioning device, more particularly to a positioning device including a slider slidable on a slide-mounting part, and a position-indicating unit co-slidable with the slider.

2. Description of the Related Art

Referring to FIG. 1, a conventional positioning device 1 includes a fixed member 11, a sliding member 12 movable relative to the fixed member 11, and a positioning member 13 co-slidable with the sliding member 12. The fixed member 11 has a wall 111 formed with a plurality of retaining grooves 112. The positioning member 13 has a first part 131 fixed to and extending from the sliding member 12, and a second part 132 extending from the first part 131 and formed with a protrusion 133.

In operation, the sliding member 12 is moved along the wall 111 of the fixed member 11 to engage the protrusion 133 of the positioning member 13 with a selected one of the retaining grooves 112 in the wall 111 of the fixed member 11. Since engagement between the protrusion 133 of the positioning member 13 and the selected retaining grooves 112 is relatively weak, the sliding member 12 is likely to be undesirably moved, and the positioning function provided by the positioning device 1 is not secure.

Another conventional positioning device 2 is illustrated in FIG. 2. The positioning device 2 shown in FIG. 2 includes a fixed member 21 formed with a plurality of retaining holes 211, a sliding member 22 mounted slidably on the fixed member 21 and formed with an engaging hole 221, and a positioning member 23 co-slidable with the sliding member 22. The engaging hole 211 is aligned with a selected one of the retaining holes 211 of the fixed member 21 when the sliding member 22 slides on the fixed member 21 to a desired position. The positioning member 23 includes a control part 231, a plug seat 232 that supports the control part 231, that is secured to the sliding member 22, and that defines a chamber therein, and a plug rod 233 including a rod portion that is fixed to the control part 231 and that is received in the chamber in the plug seat 232. The plug rod 233 further includes an engaging portion protruding from the rod portion into the engaging hole 221 of the sliding member 22. The positioning device 2 further includes a biasing member 235 sleeved on the rod portion of the plug rod 233. The plug rod 233 is movable together with the control part 231 between a positioning state, where the engaging portion of the plug rod 233 engages the selected one of the retaining holes 211 in the fixed member 21, and a releasing state, where the engaging portion of the plug rod 233 is disengaged from the selected one of the retaining holes 211 of the fixed member 21.

Compared to the positioning device 1 shown in FIG. 1, the positioning device shown in FIG. 2 has a better positioning effect and can bear a heavier load. However, alignment of the plug rod 233 with a selected one of the retaining holes 211 during movement of the sliding member 22 to a corresponding position cannot be performed smoothly.

### SUMMARY OF THE INVENTION

Therefore, the object of the present invention is to provide a positioning device that can alleviate at least one of the aforesaid drawbacks of the prior art.

According to this invention, a positioning device with position-indicating capability includes: a slide-mounting part formed with a plurality of retaining holes aligned in a longitudinal direction and having a contacting wall that is formed with a plurality of recessed portions corresponding respectively to the retaining holes; a slider slidable on the slide-mounting part in the longitudinal direction; an engaging member having an engaging protrusion, co-slidable with the slider so as to align the engaging protrusion with a selected one of the retaining holes, and movable relative to the slider between an engaging position, in which the engaging protrusion engages releasably an aligned one of the retaining holes, and a disengaging position, in which the engaging protrusion is disengaged from the aligned one of the retaining holes; and a position-indicating unit co-slidable with the slider, and including a spring arm having a free end that is in sliding contact with a corresponding one of the recessed portions of the contacting wall when the engaging protrusion is aligned with the selected one of the retaining holes.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a fragmentary schematic view to illustrate a conventional positioning device;

FIG. 2 is a fragmentary schematic sectional view to illustrate another conventional positioning device;

FIG. 3 is a fragmentary exploded perspective view to illustrate the preferred embodiment of a positioning device according to this invention;

FIG. 4 is a perspective view to illustrate the preferred embodiment of the positioning device in an assembled state;

FIG. 5 is a fragmentary perspective view to illustrate an assembled structure of an engaging member, a slider and a position-indicating unit of the preferred embodiment of the positioning device;

FIG. 6 is a fragmentary sectional view to illustrate an engaging position of the engaging member of the preferred embodiment;

FIG. 7 is a fragmentary sectional view to illustrate a disengaging position of the engaging member of the preferred embodiment; and

FIGS. 8 and 9 are fragmentary schematic sectional views to illustrate how the position-indicating unit functions when the engaging member is moved from the disengaging position to the engaging position.

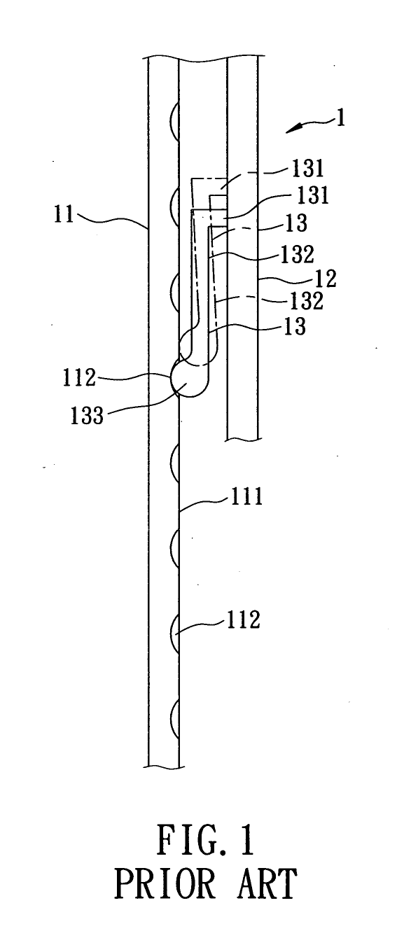

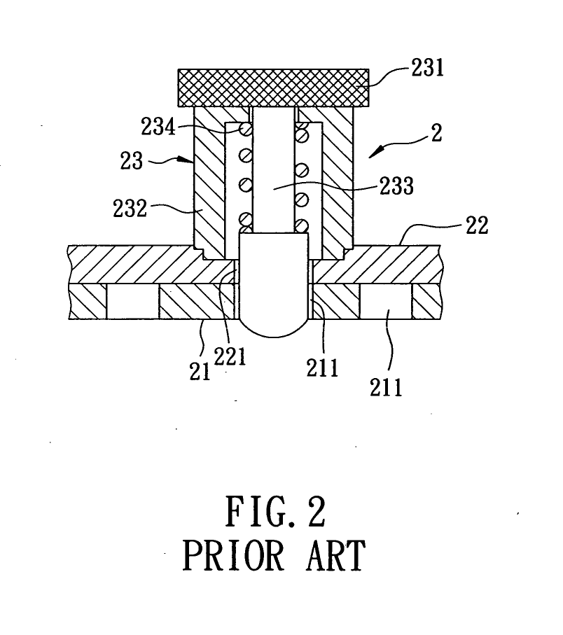

### DETAILED DESCRIPTION OF THE PREFERRED EMBODIMENT

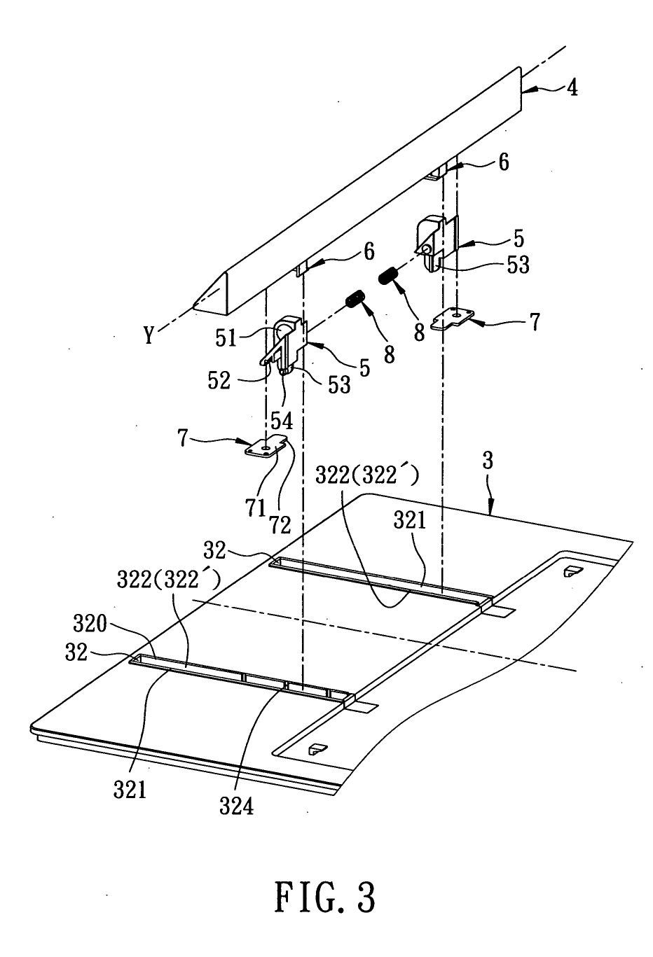

Referring to FIGS. 3, 4, and 5, the preferred embodiment of a positioning device with position-indicating capability according to this invention includes: a slide-mounting part 3 formed with a plurality of retaining holes 323 aligned in a longitudinal direction (X) and having a contacting wall 322′ that is formed with a plurality of recessed portions 324 corresponding respectively to the retaining holes 323; a slider 4 slidable on the slide-mounting part 3 in the longitudinal direction (X); an engaging member 5 having an engaging protrusion 54, co-slidable with the slider 4 so as to align the engaging protrusion 54 with a selected one of the retaining holes 323, and movable relative to the slider 4 between an engaging position, in which the engaging protrusion 54 engages releasably an aligned one of the retaining holes 323, and a disengaging position, in which the engaging protrusion 54 is disengaged from the aligned one of the retaining holes 323; and a position-indicating unit 6 co-slidable with the slider 4, and including a spring arm 61 having a free end that is in resilient sliding contact with a corresponding one of the recessed portions 324 of the contacting wall 322′ when the engaging protrusion 54 is aligned with the selected one of the retaining holes 323.

In an exemplary arrangement of this preferred embodiment, each of the recessed portions 324 of the contacting wall 322′ defines a round recess, and the free end of the spring arm 61 is formed with a round protrusion 62 that extends into the round recess of the corresponding one of the recessed portions 324 of the contacting wall 322′ when the engaging protrusion 54 is aligned with the selected one of the retaining holes 323.

In a preferred arrangement, the slide-mounting part 3 is formed with an elongated groove 32 extending in the longitudinal direction (X) and defined by a groove-defining wall 320 that has first and second wall portions 321, 322 opposite to each other in a transverse direction (Y) relative to the longitudinal direction (X). The first wall portion 321 of the groove-defining wall 320 is formed with the retaining holes 323. The second wall portion 322 of the groove-defining wall 320 defines the contacting wall 322′.

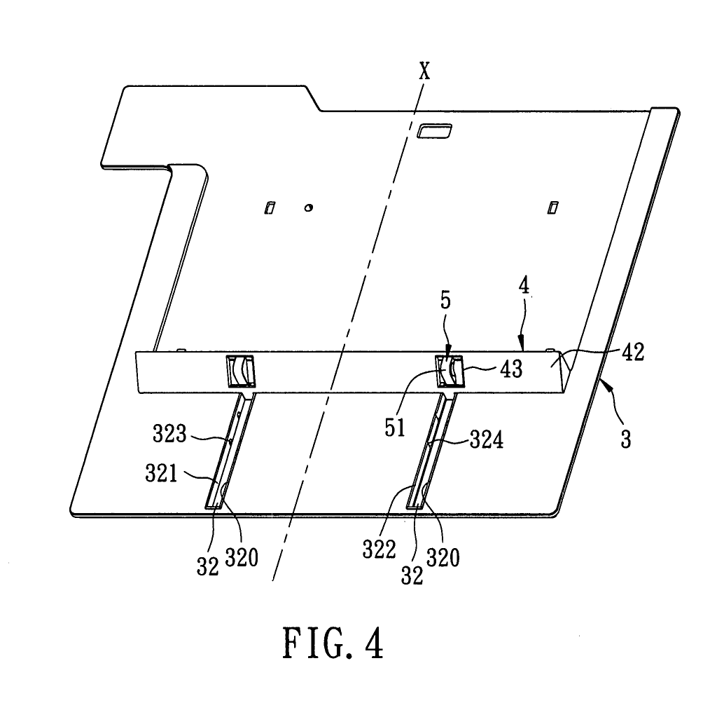

In an alternative arrangement, the slide-mounting part 3 may be formed with more than one elongated groove 32. For example, as shown in FIGS. 3 and 4, two elongated grooves 32 are formed in the slide-mounting part 3.

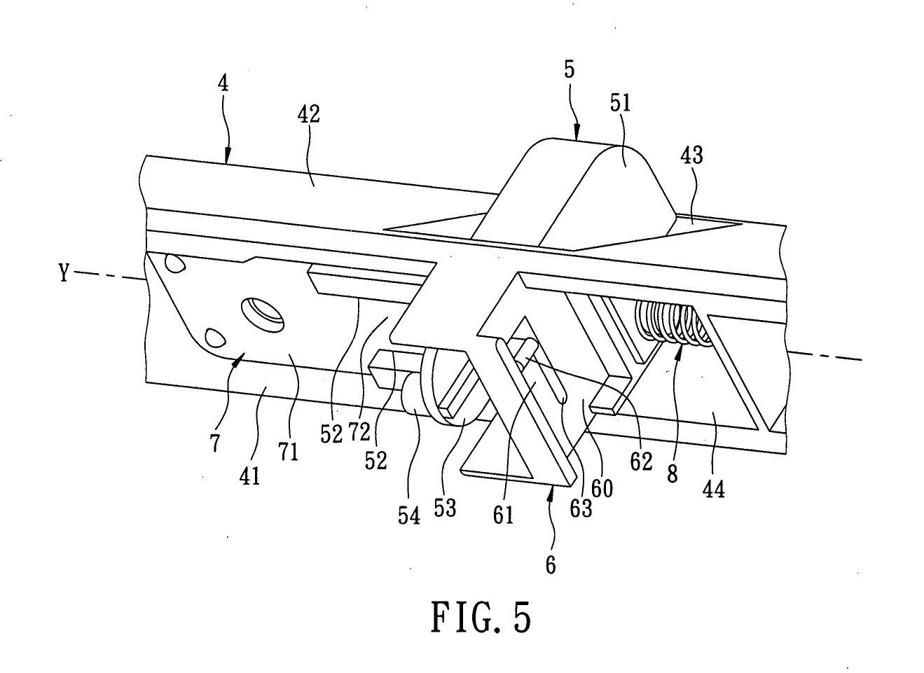

In another preferred arrangement, the slider 4 has a lower wall 41 (see FIG. 5), and the position-indicating unit 6 includes a first insert plate 60 that extends from the lower wall 41 of the slider 4 into the elongated groove 32 of the slide-mounting part 3, that faces the contacting wall 322′, and that is formed with a U-shaped through-hole 63 so as to define the spring arm 61 on the first insert plate 60.

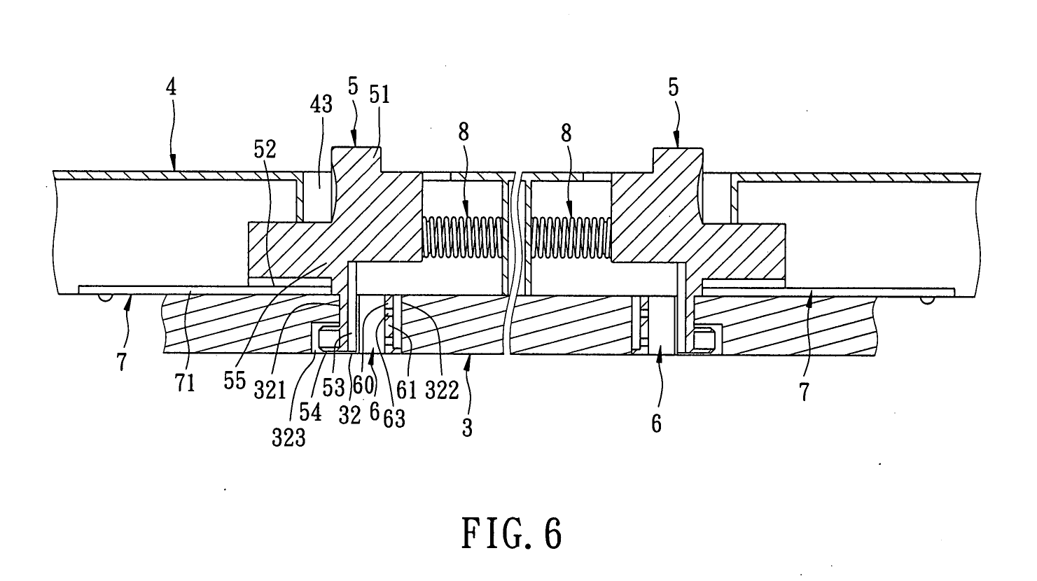

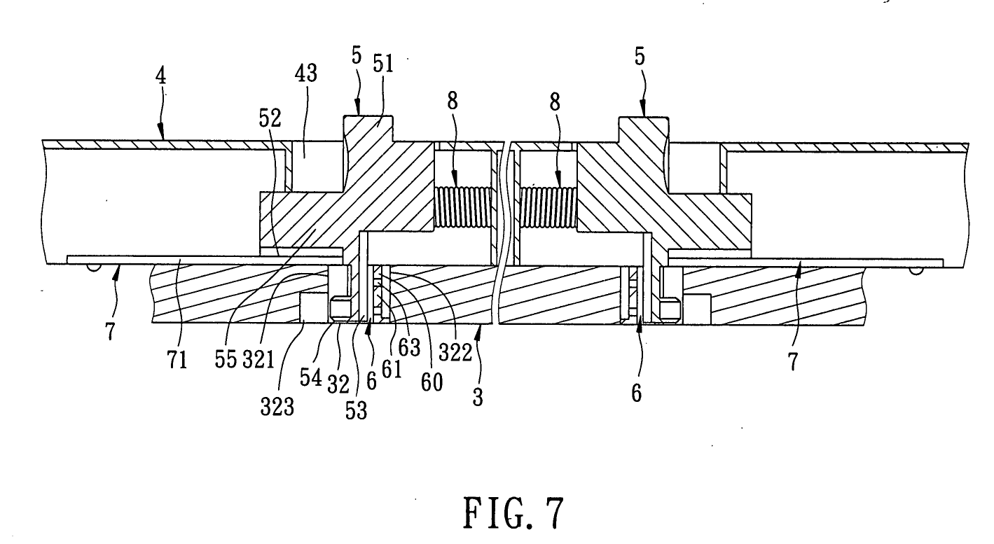

Referring further to FIGS. 6 and 7, in combination with FIGS. 3 and 5, in yet another preferred arrangement, the engaging member 5 further has a middle part 55 that is mounted slidably on the slider 4 so as to be slidable relative to the slider 4, and a second insert plate 53 that extends from the middle part 55 into the elongated groove 32 and that faces the first wall portion 321 of the groove-defining wall 320. The engaging protrusion 54 protrudes from the second insert plate 53.

The slider 4 further has an upper wall 42 (see FIG. 5), and has a mounting space 44 extending from the upper wall 42 to the lower wall 41. The middle part 55 of the engaging member 5 is received in the mounting space 44, and is formed with two opposite guiding grooves 52. The slider 4 is provided with a mounting plate 7 that has a first portion 71 secured to the lower wall 41 of the slider 4, and a second portion 72 reduced in width from the first portion 71 and having two opposite side edges extending respectively into the guiding grooves 52 in the middle part 55 of the engaging member 5 so as to permit sliding movement of the engaging member 5 relative to the slider 4.

Preferably, the engaging member 5 further has an operating upper part 51 that extends from the middle part 55 through an upper end 43 of the mounting space 44, and that projects outwardly from the upper wall 42 for facilitating operation of the engaging member 5.

Besides, in another exemplary arrangement of this preferred embodiment, the positioning device of this invention further includes a biasing member 8 for urging the engaging member 5 to the engaging position. Preferably, the biasing member 8 is a coil spring.

During operation of the preferred embodiment of this invention, referring to FIGS. 4 and 6, when no external force is applied to the engaging member 5, the engaging member 5 is urged by the biasing member 8 to maintain the engaging member 5 at the engaging position where the engaging protrusion 54 engages releasably the aligned one of the retaining holes 323. Hence, the slider 4 is positioned on the slide-mounting part 3.

Referring to FIGS. 4 and 7, when an external force, which is sufficient to overcome the biasing force of the biasing member 8, is applied to the operating upper part 51 of the engaging member 5, the engaging member 5 will be moved to the disengaging position where the engaging protrusion 54 is disengaged from the aligned one of the retaining holes 323, thereby permitting movement of the slider 4 along the elongated groove 32 in the longitudinal direction (X).

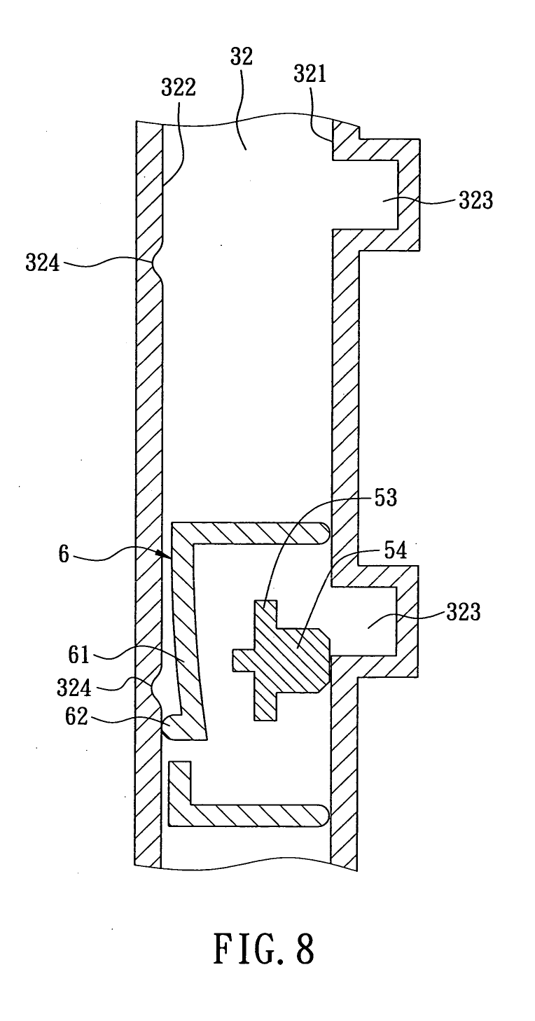

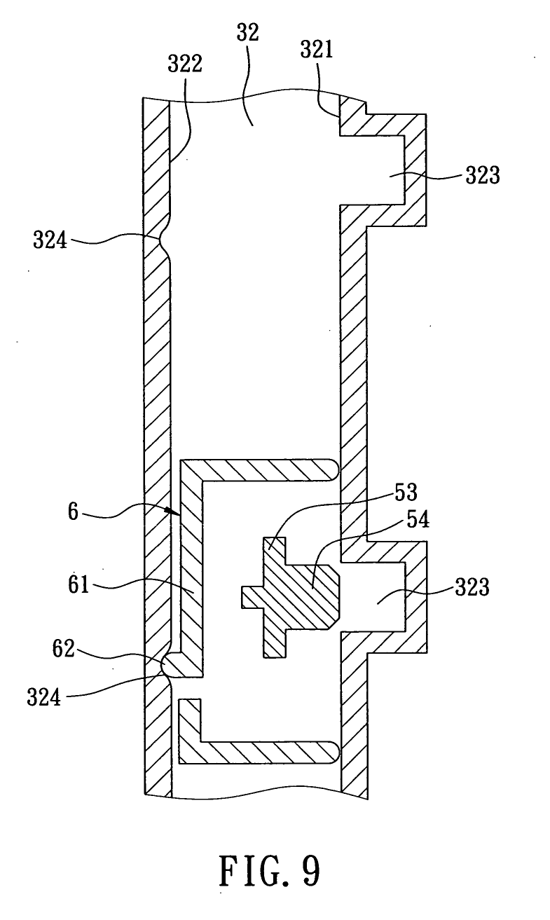

Referring to FIGS. 5, 8, and 9, during movement of the slider 4 along the elongated groove 32 as a result of the external force applied to the engaging member 5, the free end of the spring arm 61 of the position-indicating unit 6 is in sliding contact with the contacting wall 322′, and can generate a clicking sound and a feel of resistance when the free end of the spring arm 61 extends into the aligned one of the recessed portions 324 of the contacting wall 322′. Hence, the user can determine the distance that the slider 4 has moved relative to the slide-mounting part 3 with the assistance of the clicking sound and the resistance resulting from contact of the free end of the spring arm 61 with the aligned recessed portion 324.

The clicking sound indicates that the engaging protrusion 54 of the engaging member 5 has been brought into alignment with one of the retaining holes 323 of the slide-mounting part 3. Hence, the slider 4 can be re-positioned on the slide-mounting part 3 through engagement of the engaging protrusion 54 with the selected retaining hole 323, which is performed by the urging action of the biasing member 8 upon releasing the applied external force.

In view of the aforesaid, by virtue of the position-indicating unit 6, the distance that the slider 4 has been moved relative to the slide-mounting part 3 can be discernible. Hence, positioning of the slider 4 on the slide-mounting part 3 is facilitated.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A positioning device with position-indicating capability, comprising:
a slide-mounting part formed with a plurality of retaining holes aligned in a longitudinal direction and having a contacting wall that is formed with a plurality of recessed portions corresponding respectively to said retaining holes;
a slider slidable on said slide-mounting part in the longitudinal direction;
an engaging member having an engaging protrusion, co-slidable with said slider so as to align said engaging protrusion with a selected one of said retaining holes, and movable relative to said slider between an engaging position, in which said engaging protrusion engages releasably an aligned one of said retaining holes, and a disengaging position, in which said engaging protrusion is disengaged from the aligned one of said retaining holes; and
a position-indicating unit co-slidable with said slider, and including a spring arm having a free end that is in sliding contact with a corresponding one of said recessed portions of said contacting wall when said engaging protrusion is aligned with the selected one of said retaining holes.

2. The positioning device of claim 1, wherein each of said recessed portions of said contacting wall defines a round recess, said free end of said spring arm being formed with a round protrusion that extends into said round recess of the corresponding one of said recessed portions of said contacting wall when said engaging protrusion is aligned with the selected one of said retaining holes.

3. The positioning device of claim 1, wherein said slide-mounting part is formed with an elongated groove extending in the longitudinal direction and defined by a groove-defining wall that has first and second wall portions opposite to each other in a transverse direction relative to the longitudinal direction, said first wall portion of said groove-defining wall being formed with said retaining holes, said second wall portion of said groove-defining wall defining said contacting wall.

4. The positioning device of claim 3, wherein said slider has a lower wall, said position-indicating unit including a first insert plate that extends from said lower wall into said elongated groove, that faces said contacting wall, and that is formed with a U-shaped through-hole so as to define said spring arm on said first insert plate.

5. The positioning device of claim 4, wherein said engaging member further has a middle part that is mounted slidably on said slider so as to be slidable relative to said slider, and a second insert plate that extends from said middle part into said elongated groove and that faces said first wall portion of said groove-defining wall, said engaging protrusion protruding from said second insert plate.

6. The positioning device of claim 5, wherein said slider further has an upper wall, and has a mounting space extending from said upper wall to said lower wall, said middle part of said engaging member being received in said mounting space and being formed with two opposite guiding grooves, said slider being provided with a mounting plate that has a first portion secured to said lower wall of said slider, and a second portion reduced in width from said first portion and having two opposite side edges extending respectively into said guiding grooves in said middle part of said engaging member so as to permit sliding movement of said engaging member relative to said slider.

7. The positioning device of claim 6, wherein said engaging member further has an operating upper part that extends from said middle part and that projects outwardly from said upper wall of said slider.

8. The positioning device of claim 1, further comprising a biasing member for urging said engaging member to said engaging position.
